(19) United States
(12) Patent Application Publication
(10) Pub. No.: US 2026/0171625 A1
(43) Pub. Date: Jun. 18, 2026

(54) SECONDARY BATTERY HAVING ELECTRODE PLATES MADE OF COMPOSITE SUBSTRATE AND METHOD OF MANUFACTURING SAME

(71) Applicant: Samsung SDI Co., Ltd., Yongin-si (KR)

(72) Inventor: Misun Lee, Yongin-si (KR)

(73) Assignee: Samsung SDI Co., Ltd., Yongin-si (KR)

(21) Appl. No.: 19/393,774

(22) Filed: Nov. 19, 2025

(30) Foreign Application Priority Data
Dec. 18, 2024 (KR) 10-2024-0190597

(51) Int. Cl. H01M 50/536; H01M 4/66; H01M 50/103; H01M 50/105; H01M 50/533; H01M 50/55

(52) U.S. Cl. CPC H01M 50/536; H01M 4/667; H01M 4/668; H01M 50/103; H01M 50/105; H01M 50/533; H01M 50/55

(57) ABSTRACT

The present disclosure relates to a secondary battery having electrode plates made of composite substrates and a manufacturing method that facilitates the welding of a strip conductor. According to an aspect of the present disclosure, there is provided a secondary battery including an exterior material; an electrode assembly accommodated in the exterior material including an electrode plate in which a coated portion coated with an electrode material and an uncoated portion which is not coated with the electrode material are formed on a composite substrate including a polymer layer and a conductive layer, a conductive plate attached to the conductive layer of the uncoated portion of the electrode plate included in the electrode assembly, and a strip conductor welded to the conductive plate.

### CROSS-REFERENCE TO RELATED APPLICATIONS

This present application claims priority to and the benefit under 35 U.S.C. § 119(a)-(d) of Korean Patent Application No. 10-2024-0190597, filed on Dec. 18, 2024, in the Korean Intellectual Property Office, the entire disclosure of which is incorporated herein by reference.

### FIELD

The present disclosure relates to a secondary battery and a method of manufacturing the same.

### BACKGROUND

Unlike primary batteries that cannot be charged, secondary batteries are batteries that can be charged and discharged. Typically, a secondary battery includes an electrode assembly formed of positive and negative electrode plates and a separator.

The positive or negative electrode plates may be manufactured through a coating process of coating one or both surfaces of an electrode substrate with an active material mixture, a roll pressing process of pressing and stretching the electrode plates coated with the mixture material through the coating process to form thin and flat electrode plates, a slitting process of cutting the coated electrode plates in multiple rows in a length direction to separate the cut electrode plates into individual electrode plates, and a notching process of cutting the separated individual electrode plate in a transverse direction, removing unnecessary portions, and forming tabs.

The herein information disclosed in this Background section is for enhancement of understanding of the background of the present disclosure, and therefore, it may contain information that does not constitute a related (or prior) art.

### SUMMARY

The present disclosure proposes a secondary battery having electrode plates made of composite substrates and a manufacturing method that facilitates the welding of a strip conductor.

According to aspects of the present disclosure, there is provided a secondary battery including an exterior material, an electrode assembly accommodated in the exterior material including an electrode plate in which a coated portion coated with an electrode material and an uncoated portion which is not coated with the electrode material are formed on a composite substrate including a polymer layer and a conductive layer, a conductive plate attached to the conductive layer of the uncoated portion of the electrode plate included in the electrode assembly, and a strip conductor welded to the conductive plate.

According to aspects of the present disclosure, there is provided a method of manufacturing a secondary battery, which includes manufacturing an electrode plate in which a coated portion coated with an electrode material and an uncoated portion which is not coated with the electrode material are formed on a composite substrate including a polymer layer and a conductive layer, manufacturing an electrode assembly by assembling electrode plates, attaching a conductive plate to the conductive layer of the uncoated portion of the electrode plate included in the electrode assembly, and welding a strip conductor to the conductive plate.

Aspects and features of the present disclosure are not limited to those described herein, and other aspects and features not specifically mentioned herein will be clearly understood by those skilled in the art from the description of the present disclosure herein.

### BRIEF DESCRIPTION OF THE DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings, in which:

FIG. 1 is a schematic diagram illustrating an exterior of an electrode assembly of a secondary battery according to some embodiments of the present disclosure;

FIG. 2 is an exploded view for describing a stacked structure of electrode plates of the electrode assembly;

FIG. 3 is a side view;

FIG. 4 is a cross-sectional view illustrating a composite substrate;

FIG. 5 is a schematic diagram illustrating a strip conductor welded to an electrode tab of the electrode plates;

FIG. 6 is a cross-sectional view illustrating the electrode plate for describing the welding principle of a composite substrate-strip conductor according to the present disclosure;

FIGS. 7 to 11B are diagrams for describing a method of manufacturing a secondary battery according to some embodiments of the present disclosure;

FIG. 12 is a schematic diagram illustrating a pouch-type secondary battery to which the present disclosure can be applied; and

FIG. 13 is a schematic diagram illustrating a prismatic secondary battery to which the present disclosure can be applied.

### DETAILED DESCRIPTION

Hereinafter, embodiments of the present disclosure will be described, in detail, with reference to the accompanying drawings. The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her disclosure in the best way. The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. The same reference numerals designate the same elements.

References to two compared elements, features, etc. as being “the same” may mean that they are “substantially the same.” Thus, the phrase “substantially the same” may include a case having a deviation that is considered low in the art, for example, a deviation of 5% or less. In addition, uniformity of a parameter in a predetermined region may imply uniformity from an average perspective.

Although the terms first, second, and the like are used to describe various components, these components are substantially not limited by these terms. These terms are only used for distinguishing one component from another component, and unless otherwise stated, it is of course that a first component may also be a second component.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.” As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list.

Throughout the specification, if “A and/or B” is stated, it means A, B or A and B, unless otherwise stated and if “C to D” is stated, it means C or more and D or less, unless otherwise stated.

When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below.

The terminology used herein is for the purpose of describing embodiments of the present disclosure and is not intended to limit the present disclosure.

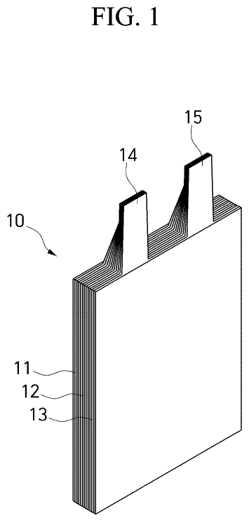

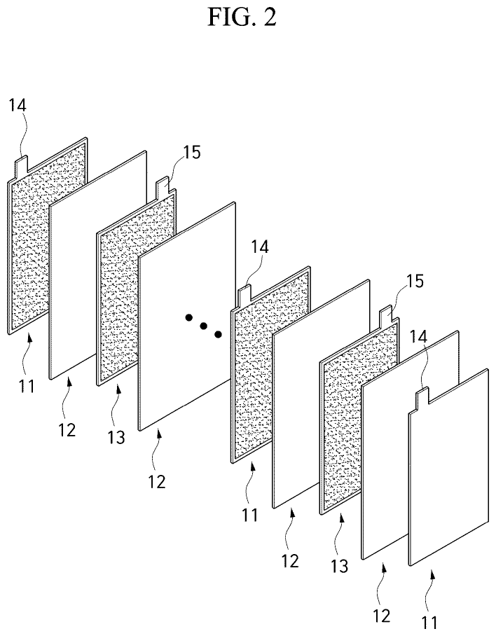

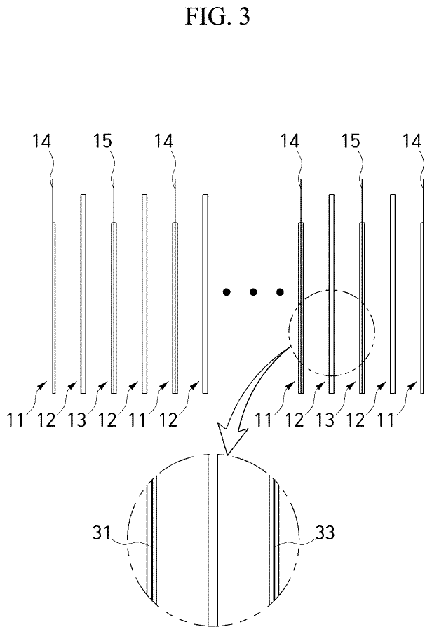

FIG. 1 is a schematic diagram illustrating an electrode assembly of a secondary battery according to some embodiments of the present disclosure. FIG. 2 is an exploded view for describing a stacked structure of a first electrode plate 11, a separator 12, and a second electrode plate 13 of an electrode assembly 10, and FIG. 3 is a side view.

As shown in the drawings, the electrode assembly 10 may be formed by stacking the first electrode plate 11, the separator 12, and the second electrode plate 13, which are formed in a plate shape or a film shape, and alternatively, the electrode assembly 10 may be a Z-stack electrode assembly in which a first electrode plate and a second electrode plate are inserted on both sides of a separator bent in a Z shape. In addition, one or more electrode assemblies 10 may be disposed and accommodated inside a case, i.e., exterior material, but the number of electrode assemblies is not limited in the present disclosure. The first electrode plate 11 of the electrode assembly 10 may serve as a negative electrode and the second electrode plate 13 thereof may serve as a positive electrode, or vice versa.

The first electrode plate 11 may be formed by applying (e.g., coating or depositing) a first electrode active material, such as graphite or carbon, onto a first electrode substrate 31. The first electrode plate 11 may include a first electrode tab 14 (e.g., a first uncoated portion), which is a region to which the first electrode active material is not applied. The first electrode tab 14 may be connected to an external first terminal. In some embodiments, when the first electrode plate 11 is manufactured, the first electrode tab 14 may be formed by being cut in advance to protrude to (or protrude from) one side of the electrode assembly 10, or the first electrode tab 14 may protrude to one side of the electrode assembly 10 more than (e.g., farther than or beyond) the separator 12 without being separately cut.

The second electrode plate 13 may be formed by applying (e.g., coating or depositing) a second electrode active material, such as a transition metal oxide, onto a second electrode substrate 33. The second electrode plate 13 may include a second electrode tab 15 (e.g., a second uncoated portion), which is a region to which the second electrode active material is not applied. The second electrode tab 15 may be connected to an external second terminal. In some embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more than (e.g., farther than or beyond) the separator 12 without being separately cut.

The separator 12 prevents a short-circuit between the first electrode plate 11 and the second electrode plate 13 while allowing movement of lithium ions therebetween. The separator 12 may be made of, for example, a polyethylene film, a polypropylene film, a polyethylene-polypropylene film, or the like.

In some embodiments, the electrode assembly 10 may be accommodated in an exterial material along with an electrolyte. In a pouch-type secondary battery, an electrode assembly 10 may be accommodated in a pouch made of flexible material. In a cylindrical or prismatic secondary battery, an electrode assembly 10 may be accommodated in a cylindrical or prismatic metal casing.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As examples, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0≤a≤2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the herein formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x≤2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99.5 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on each other.

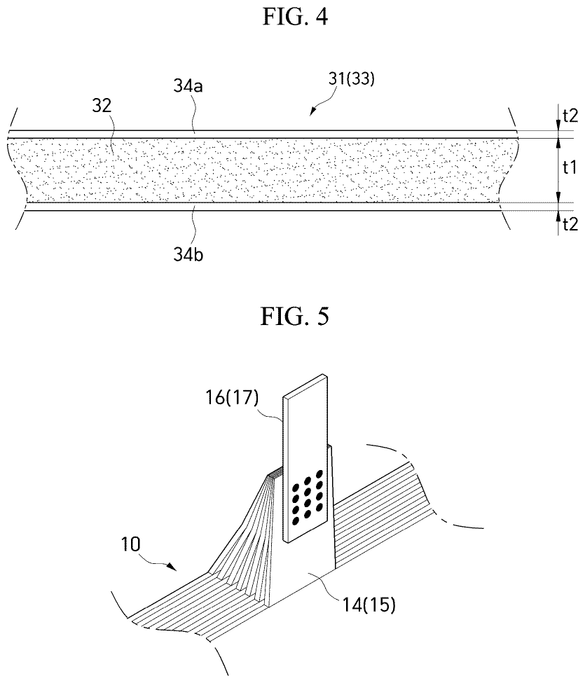

FIG. 4 is a cross-sectional view of a composite substrate that may be used as substrates 31 and 33 of the first electrode plate 11 and the second electrode plate 13 (hereinafter, collectively referred to as an “electrode plate 11”).

As shown in the drawings, each of the composite substrates 31 and 33 has a structure in which thin conductive layers 34a and 34b are provided on both sides of an intermediate polymer layer 32. For example, a thickness t1 of the polymer layer 32 is about 8 μm, and a thickness t2 of each of the conductive layers 34a and 34b is about 1 μm. Therefore, a total thickness of each of the composite substrates 31 and 33 is about 10 μm. This thickness is similar to that of a conventional substrate.

Since there is no metal layer inside a substrate when electrode plates are manufactured as the composite substrates 31 and 33, the weight of an electrode assembly can be reduced, and even when foreign materials infiltrate the electrode plates, the probability of short circuits between the electrode plates can be reduced due to the internal polymer layer.

FIG. 5 is a schematic diagram illustrating that strip conductors 16 and 17 are welded to the electrode tabs 14 and 15 of the electrode assembly 10.

In some embodiments, the strip conductors 16 and 17 (hereinafter, collectively referred to as a “strip conductor 16”) serve to electrically connect an uncoated portion (an area which is not coated with an electrode material) of each of the composite substrates 31 and 33 (hereinafter, collectively referred to as a “composite substrate 31”) of the electrode assembly 10 or the electrode tabs 14 and 15 (hereinafter, collectively referred to as an “electrode tab 14”) formed on the uncoated portion and a terminal (not shown) exposed to the outside of an exterior material, e.g., a battery can (or a case). In embodiments, the strip conductors 16 and 17 may themselves be exposed to the outside of the exterior material, e.g., battery can (or case), to serve as terminals. As described herein, the electrode tab 14 may be included in or formed from the uncoated portion of the composite substrate 31. For example, in the case of a lithium secondary battery, a coated portion, which is coated with the electrode material, of the composite substrate 31 undergoes an electrochemical reaction with lithium ions, and the coated portion which is not coated with the electrode material serves as a connector with an external terminal. As shown in FIG. 2, the uncoated portion may be notched using a mold or a laser to form the electrode tab 14, and the strip conductor 16 or an external lead wire (not shown) may be welded to the electrode tab 14. According to embodiments, the strip conductor 16 or an external lead wire (not shown) may be welded to the uncoated portion without a separate electrode tab 14 (a secondary battery having a structure without an electrode tab is referred to as a tabless battery).

The welding that should be performed to electrically connect the electrode tabs 14 in FIG. 5 is difficult to perform directly due to the intermediate polymer layer 32 in FIG. 4 that constitutes the composite substrate 31. Since the conventional device is formed of a solid conductor without the intermediate polymer layer 32, a plurality of electrode tabs 14 have been able to be easily welded using ultrasonic welding. In addition, in this way, the strip conductor 16 have been able to be easily welded to the electrode tabs 14 of a conventional substrate welded by ultrasonic welding.

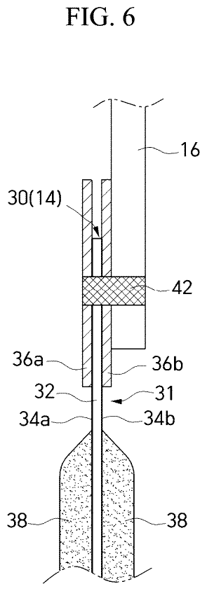

FIG. 6 is a cross-sectional view illustrating the electrode plate for describing the welding principle of the composite substrate 31-strip conductor 16 according to the present disclosure.

Conductive plates 36a and 36b are attached to the uncoated portion 30 rather than a coated portion 38, which is coated with an electrode material, of the conductive layers 34a and 34b on a surface of the composite substrate 31, or to the conductive layers 34a and 34b on both sides of the electrode tab 14 formed on the uncoated portion 30, and the strip conductor 16 is welded to one of the conductive plates 36a and 36b to form a welded portion 42 that passes through the conductive plate 36a or 36b on the opposite side. As the intermediate polymer layer 32 of the composite substrate 31 is melted by a beam emitted for welding, the two conductive plates 36a and 36b attached on both sides and the strip conductor 16 are welded to form the welded portion 42.

A substrate for a conventional electrode plate (hereinafter, a “conventional substrate”) may be used as the conductive plates 36a and 36b attached to the conductive layers 34a and 34b of the composite substrate 31, but a general metal plate other than a conventional substrate for an electrode plate may also be used. The same type of metal material (Cu, Al, or the like) of the conventional substrate may be used as a material of the conductive plates 36a and 36b.

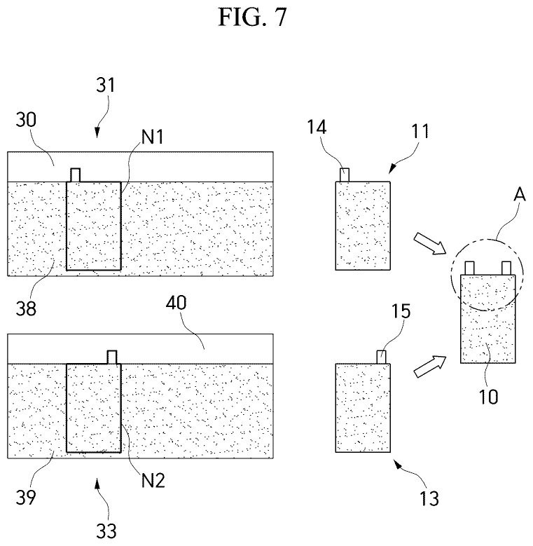

FIGS. 7 to 11B are diagrams for describing a method of manufacturing a secondary battery according to some embodiments of the present disclosure. The following description of the manufacturing method will facilitate the understanding of the configuration of the secondary battery according to the present disclosure.

First, FIG. 7 is a diagram for describing a manufacturing process of the electrode plates 11 and 13. The first electrode plate 11 is manufactured by notching the coated portion 38, which is coated with an electrode material, of the composite substrate 31 for a first electrode plate made of a polymer layer and a conductive layer and the uncoated portion 30, which is not coated with the electrode material, along an outline of N1. The electrode tab 14 may be formed in the uncoated portion 30 of the composite substrate 31 by the notching in the N1 shape.

Similarly, the second electrode plate 13 is manufactured by notching the coated portion 39, which is coated with the electrode material, of the composite substrate 33 for a second electrode plate and the uncoated portion 40, which is not coated with the electrode material, along an outline of N2. The electrode tab 15 may be formed in the uncoated portion 40 of the composite substrate 33 by the notching in the N2 shape.

The manufactured first and second electrode plates 11 and 13 and a separator (not shown) are assembled to manufacture the electrode assembly 10.

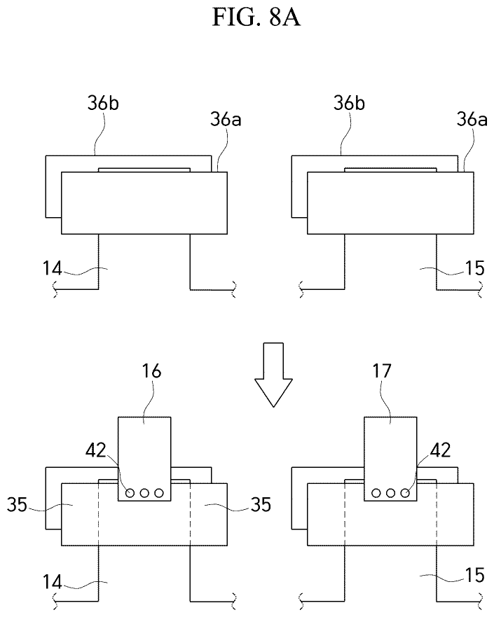

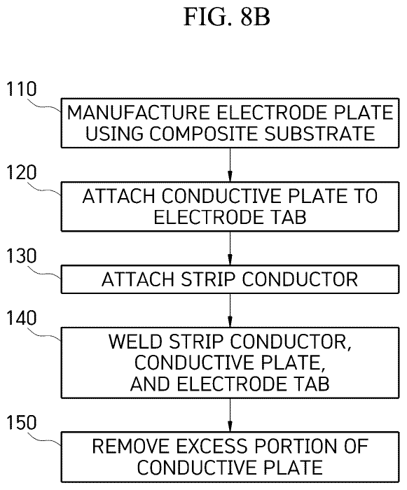

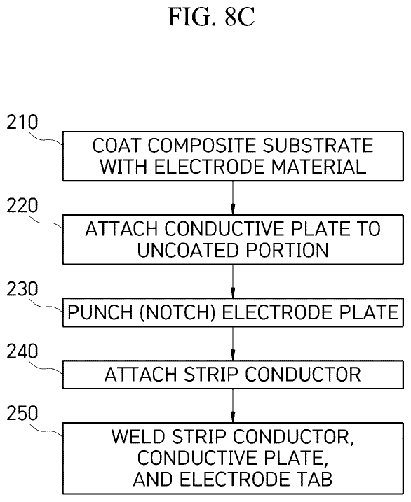

FIG. 8A is an enlarged view of portion A of FIG. 7 for describing a process that may be performed after the operation of manufacturing the electrode assembly of FIG. 7. The process of FIG. 8A will be described through a flowchart of FIG. 8B or 8C.

First, FIGS. 8A and 8B will be described together.
110: As described in FIG. 7, the electrode plates 11 and 13 are made of composite substrates, and the electrode assembly 10 is manufactured.
120: The conductive plates 36a and 36b are attached to the composite substrate uncoated portions 30 and 40 of the electrode plates 11 and 13 included in the manufactured electrode assembly 10 or to both surfaces of the electrode tabs 14 and 15 formed as in FIG. 7 (see an upper portion of FIG. 8A). As described herein, the conductive plates 36a and 36b may be general materials or general metal plates used for manufacturing secondary battery electrode plates.
130: The strip conductor 16 is attached to one of the conductive plates 36a and 36b on both sides (see a lower portion of FIG. 8A).
140: The strip conductors 16 and 17, the conductive plates 36a and 36b, the electrode tabs 14 and 15, or the uncoated portions 30 and 40 are welded (see the lower portion of FIG. 8A). The welded portion 42 is shown in FIG. 8B. Laser welding may be used as a welding method, but the present disclosure is not limited thereto. For example, ultrasonic welding, resistance welding, etc. may also be used.
150: When the conductive plates 36a and 36b are larger than the electrode tabs 14 and 15, an excess portion 35 is cut and removed. When the conductive plates 36a and 36b are first cut to the same size as the electrode tabs 14 and 15 and prepared, operation 150 is unnecessary.

On the other hand, FIG. 8C shows embodiments in which the process of FIG. 8B is slightly modified. As in FIG. 7, embodiments of FIG. 8B is a process of notching and punching the first electrode plate 11 and the second electrode plate 13 from the composite substrates 31 and 33 and then attaching the conductive plates 36a and 36b. However, in embodiments of FIG. 8C, which will be described herein, a process of attaching the conductive plates 36a and 36b before the punching of the first electrode plate 11 and the second electrode plate 13 is performed. A specific process order is as follows.
210: The composite substrates 31 and 33 are coated with an electrode material to form coated portions 38 and 39 and uncoated portions 30 and 40.
220: In this state, the conductive plates 36a and 36b are attached to the two conductive layers 34a and 34b of the uncoated portions 30 and 40.
230: The first electrode plate 11 and the second electrode plate 13 are punched while the conductive plates 36a and 36b are attached. Therefore, the conductive plates 36a and 36b may be punched in the same shape as the electrode tab 14.
240: The strip conductor 16 is attached to one of the conductive plates 36a and 36b.
250: The strip conductors 16 and 17, the conductive plates 36a and 36b, and the electrode tabs 14 and 15 are welded.
150: When the conductive plates 36a and 36b are larger than the electrode tabs 14 and 15, the excess portion 35 is cut and removed. If the conductive plates 36a and 36b are first cut to the same size as electrode tabs 14 and 15 and prepared, operation 150 may be unnecessary.

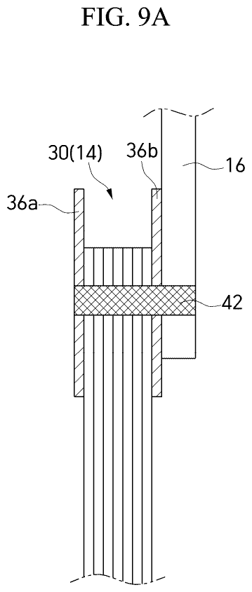

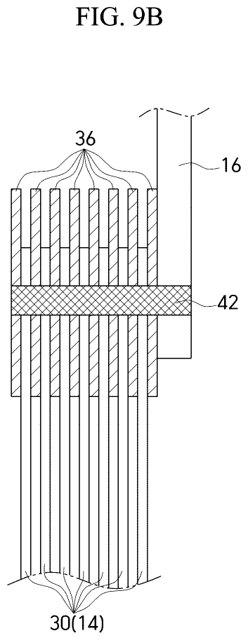

FIG. 9A shows one method of attaching the conductive plates 36a and 36b to the uncoated portions 30 or the electrode tabs 14 of a plurality of composite substrate electrode plates.

Here, the conductive plates 36a and 36b are attached to the uncoated portions of the outermost electrode plates on both sides among the plurality of electrode plates or the electrode tabs 14. Since a welded portion 42 passing through the strip conductor 16, the conductive plates 36a and 36b, and the uncoated portion 30 or the electrode tab 14 is formed, all electrode plates may be electrically connected even when the conductive plates 36a and 36b are not attached to the electrode plates located in the middle, but only attached to at least the outermost electrode plates on both sides. This means that the conductive plates 36a and 36b are attached at least to the outermost electrode plates on both sides so that it is possible to intermittently attach the conductive plates 36a and 36b to any position of the uncoated portion 30 or the electrode tab 14 of the electrode plates located in the middle.

FIG. 9B shows a method of attaching conductive plates in a different manner from FIG. 9A.

Here, the conductive plate 36 is attached to the uncoated portions 30 or the electrode tabs 14 of all electrode plates. In the case of this method, a thickness of the electrode assembly 10 increases, but connectivity between the electrode plates may be strengthened and internal resistance may be reduced.

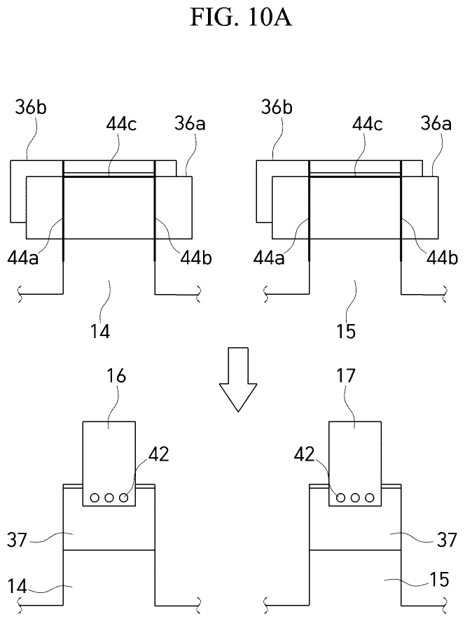

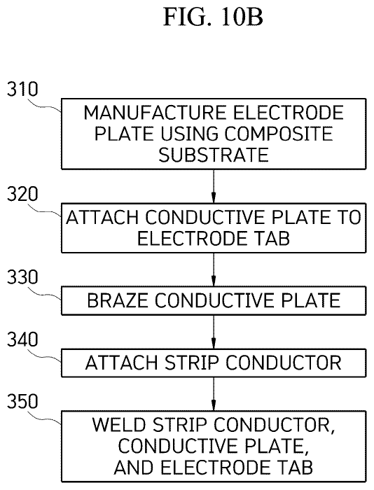

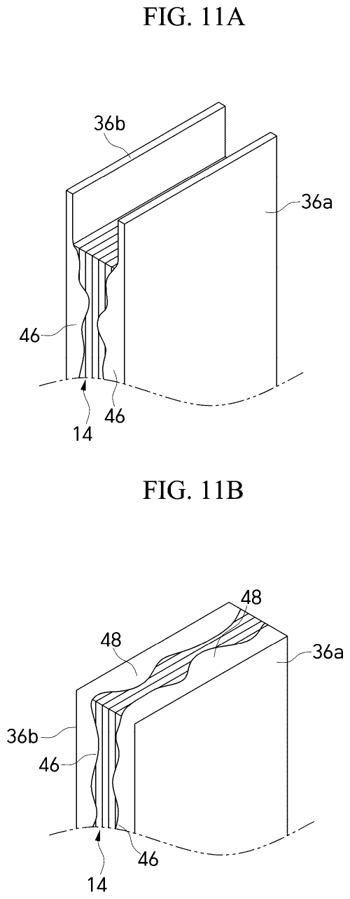

FIGS. 10A and 10B are for describing a method of manufacturing a secondary battery according to embodiments of the present disclosure. FIG. 10B will be described with reference to FIG. 10A.
310: As described in FIG. 7, electrode plates 11 and 13 are made of composite substrates, and an electrode assembly 10 is manufactured.
320: Conductive plates 36a and 36b are attached to composite substrate uncoated portions 30 and 40 of the electrode plates 11 and 13 included in the manufactured electrode assembly 10 or to both surfaces of electrode tabs 14 and 15 formed as in FIG. 7 (see an upper portion of FIG. 10A). As described herein, the conductive plates 36a and 36b may be general materials or general metal plates used for manufacturing secondary battery electrode plates.
330: The attached conductive plates 36a and 36b are brazed into the same shape as the electrode tab 14. As shown in FIG. 10A, the brazed area may be an area corresponding to left and right vertical sides 44a and 44b of the electrode tab 14, and an area corresponding to an upper horizontal side 44c may be additionally brazed. In addition to cutting the conductive plates 36a and 36b into the same shape as the electrode tab 14, a brazing effect is that the conductive plates 36a and 36b may be brazed and melted to seep between the electrode tabs 14 as shown in FIGS. 11A and 11B. When the melted conductive plates 36a and 36b seep between the electrode tabs 14, weld quality may be greatly improved when the strip conductor 16 is subsequently welded. FIG. 11A shows a case in which the lateral side 46 of the conductive plates 36a and 36b are melted when portions corresponding to the left and right vertical sides 44a and 44b of the electrode tab 14 are brazed as shown in FIG. 10A. FIG. 11B shows a melted exterior of an upper side 48 of the conductive plates 36a and 36b when additional brazing is performed on portions corresponding to the upper horizontal side 44c of electrode tab 14 as shown in FIG. 10A.
340: The strip conductor 16 is attached to one of the conductive plates 36a and 36b on both sides (see a lower portion of FIG. 10A).
350: The strip conductors 16 and 17, the brazed conductive plate 37, and the electrode tabs 14 and 15 are welded (see the lower portion of FIG. 10A). The welded portion 42 is shown in FIG. 10A.

Laser welding may be used as a welding method, but the present disclosure is not limited thereto.

For example, ultrasonic welding, resistance welding, etc. may also be used.

The electrode assembly 10 manufactured through the herein-described process is accommodated in an exterior material and manufactured into a secondary battery.

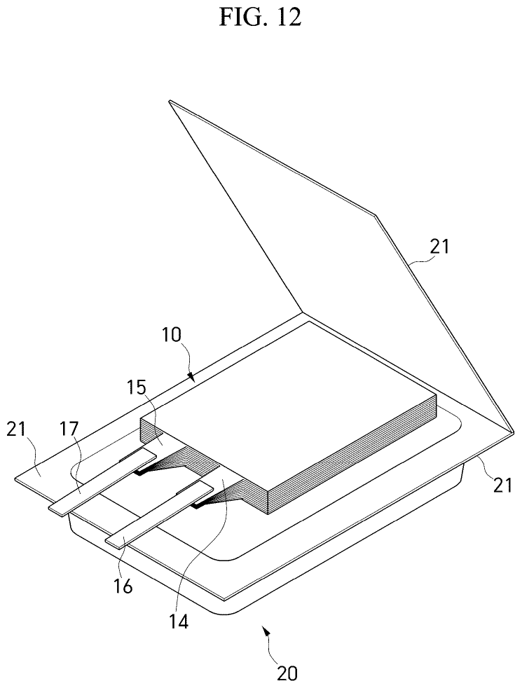

FIG. 12 is a schematic diagram illustrating a pouch-type secondary battery to which the present disclosure can be applied.

The pouch-type secondary battery may include the electrode assembly 10 and a pouch 20 that accommodates the electrode assembly 10. The first electrode tabs 14 and the second electrode tabs 15 of the electrode assembly 10 as shown in FIG. 1 may be welded to the first strip conductor 16 and the second strip conductor 17 to be electrically connected thereto, respectively. Tab films 18 for insulation from the pouch 20 may be bonded to the first strip conductor 16 and the second strip conductor 17.

The exterior material, i.e., pouch 20, may be sealed such that sealing portions 21 at the edges come into contact with each other while the electrode assembly 10 is accommodated in the pouch 20. In this case, the sealing may be achieved while the tab films 18 are interposed between the sealing portions 21. The sealing portion 21 of the pouch 20 is made of a heat sealing material. Since heat sealing materials generally have weak adhesion to metals, the heat sealing material may be fused to the pouch 20 by interposing the tab film 18 in the form of a thin film.

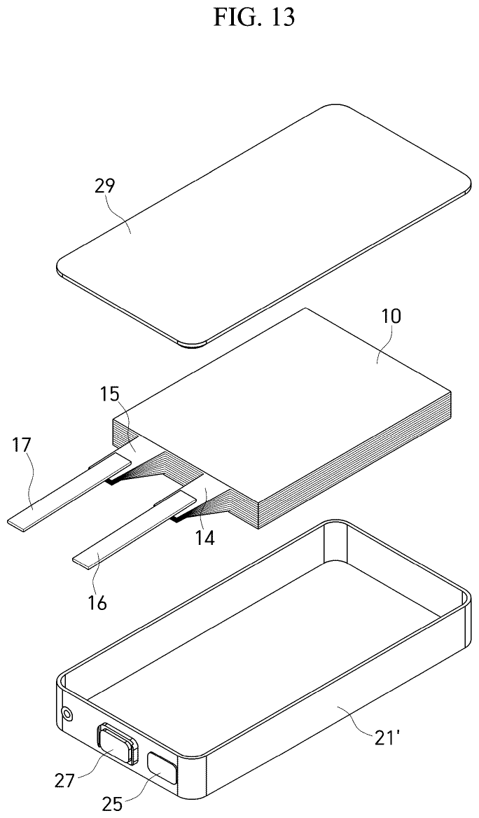

As examples to which the present disclosure can be applied, the prismatic secondary battery shown in FIG. 13 has a structure in which a wide lateral surface of a can 21′, as the exterior material, of a battery is open, the electrode assembly 10 is inserted into the opening, and a cover 29 covers the opening. The first strip conductor 16 and the second strip conductor 17, which are electrically connected to a first terminal 25 and a second terminal 27 exposed to the outside of a can 22, may be connected to the first electrode tab 14 and the second electrode tab 15 of the electrode assembly 10 inside the outer can 22 by welding.

According to the present disclosure, by manufacturing an electrode plate using a composite substrate, a secondary battery in which the weight of an electrode assembly can be reduced and, the probability of a short circuit occurring between electrode plates can be reduced by an internal polymer layer even when foreign materials infiltrate into an electrode plate can be provided. In addition, according to a method of manufacturing a secondary battery of the present disclosure, welding between the composite substrate, a strip conductor, and an electrode tab can be easily performed.

Although the present disclosure has been described herein with respect to embodiments thereof, the present disclosure is not limited thereto. Various modifications and variations can be made thereto by those skilled in the art within the spirit of the present disclosure as defined by the appended claims and their equivalents.

What is claimed is:

1. A secondary battery comprising:
an exterior material;
an electrode assembly accommodated in the exterior material and comprising an electrode plate in which a coated portion coated with an electrode material and an uncoated portion which is not coated with the electrode material are formed on a composite substrate including a polymer layer and a conductive layer;
a conductive plate attached to the conductive layer of the uncoated portion of the electrode plate included in the electrode assembly; and
a strip conductor welded to the conductive plate.

2. The secondary battery as claimed in claim 1, wherein the uncoated portion comprises an electrode tab.

3. The secondary battery as claimed in claim 1, wherein:
the electrode plate is provided as a plurality of electrode plates; and
the conductive plate is attached to an uncoated portion of at least an outermost electrode plate among the plurality of electrode plates.

4. The secondary battery as claimed in claim 1, wherein:
the electrode plate is provided as a plurality of electrode plate; and
the conductive plate is attached to uncoated portions of all the electrode plates.

5. The secondary battery as claimed in claim 1, wherein the conductive plate is a substrate for a secondary battery electrode plate.

6. The secondary battery as claimed in claim 1, further comprising a terminal electrically connected to the strip conductor and exposed to an outside of the exterior material.

7. The secondary battery as claimed in claim 1, wherein the exterior material is an exterior pouch for a pouch-type battery.

8. The secondary battery as claimed in claim 1, wherein the exterior material is an outer can for a prismatic battery.

9. A method of manufacturing a secondary battery, comprising:
manufacturing an electrode plate in which a coated portion coated with an electrode material and an uncoated portion which is not coated with the electrode material are formed on a composite substrate including a polymer layer and a conductive layer;
manufacturing an electrode assembly by assembling the electrode plate;
attaching a conductive plate to the conductive layer of the uncoated portion of the electrode plate included in the electrode assembly; and
welding a strip conductor to the conductive plate.

10. The method as claimed in claim 9, wherein the manufacturing of the electrode plate comprises forming an electrode tab on the uncoated portion.

11. The method as claimed in claim 10, further comprising, after the welding of the strip conductor to the conductive plate, removing an excess portion of the conductive plate that is larger than the electrode tab.

12. The method as claimed in claim 10, further comprising, before the welding of the strip conductor to the conductive plate, brazing the conductive plate.

13. The method as claimed in claim 9, wherein:
the manufacturing of the electrode plate comprises manufacturing a plurality of electrode plates; and
the attaching of the conductive plate to the conductive layer of the uncoated portion of the electrode plate comprises attaching a conductive plate to an uncoated portion of at least an outermost electrode plate among the plurality of electrode plates.

14. The method as claimed in claim 9, wherein:
the manufacturing of the electrode plate comprises manufacturing a plurality of electrode plates; and
the attaching of the conductive plate to the conductive layer of the uncoated portion of the electrode plate comprises attaching conductive plates to the uncoated portions of all the electrode plates.

15. The method as claimed in claim 9, further comprising, before the welding of the strip conductor to the conductive plate, brazing the conductive plate.

16. The method as claimed in claim 9, wherein the conductive plate is a substrate for a secondary battery electrode plate.

17. The method as claimed in claim 9, further comprising accommodating the electrode assembly in an exterior material.

18. The method as claimed in claim 17, further comprising electrically connecting a terminal exposed to an outside of the exterior material to the strip conductor.

19. The method as claimed in claim 17, wherein the exterior material is an exterior pouch for a pouch-type battery.

20. The method as claimed in claim 17, wherein the exterior material is an outer can for a prismatic battery.
